(19) United States
(12) Patent Application Publication
(10) Pub. No.: US 2001/0037365 A1
(43) Pub. Date: Nov. 1, 2001

(54) Method and system for linked communication between client stations

(76) Inventors: P. Read Montague, Sugar Land, TX (US); Ronald T. Nixon, Sugar Land, TX (US)

Correspondence Address: Edward D. Steakley, FULBRIGHT & JAWORSKI L.L.P., Suite 5100, 1301 McKinney, Houston, TX, 77010-3095, US

(21) Appl. No.: 09/809,481

(22) Filed: Mar. 15, 2001

Related U.S. Application Data
(60) Provisional application No. 60/189,567, filed on Mar. 15, 2000.

(51) Int. Cl. G06F 15/16

(52) U.S. Cl. 709/204; 709/218; 709/219

(57) ABSTRACT

A system and method adapted to linking a group of client stations such that the operator of one or more client stations can guide or dictate, at least partially, what is viewed on the other client stations. A first user of a client station may guide and restrict the browsing of URL resources of other user client stations. The first user client station transmits a URL resource identifier to a server station, which then sends the URL resource identifier to authorized users of a group. The client stations of the group users are then directed to the URL resource submitted by the first user client station. The system allows a user of the group to annotate the URL resource or web page, and such annotation is contemporaneously displayed on each of the group client stations.

This application claims the benefit of the filing date of Provisional Application Serial No. 60/189,567 filed Mar. 14, 2000, now pending (hereby incorporated by reference for all purposes).

### BACKGROUND

The present invention relates generally to a system and/or method of communication or interaction between two or more client stations, computers, terminals, digital personal assistant devices such Palm Pilots and/or other electronic locations (collectively “client stations”) in a client-server network such as the Internet and/or Intranet, or other interactive computer network or via a standard telecom network. Further, the present invention relates to a system and/or method particularly adapted to linking a group of client stations such that the operator of one or more client stations can guide or dictate, at least partially, what is viewed on the other client stations.

### SUMMARY OF THE INVENTION

It is one of several objects of the invention to provide a system and/or method for linking a plurality of client stations, terminals, digital personal assistant devices, computers, or other electronic locations (hereinafter “client stations”). It is another object of the invention to provide a system and/or method for allowing a user(s) of one client station to “browse” together with one or more users of other client stations. It is yet another object of the invention to provide such a system and/or method wherein/whereby one user(s) in a communication group can restrict (e.g., guide) the “browsing” activity of another user(s) in the group.

In one aspect of the invention, a method is provided that is implemented through or via a client-server system and for allowing a first client station to cause a second client station to display a predetermined “resource page” (see definition below). The client stations other than the first client station are referred to as a passenger station. The method may include the steps of providing a client-server system including a first client station, a second client station, and a server station, wherein the stations are disposed in electronic communication and providing a “browser” program for displaying resource pages on the second client station. The method further includes the steps of, at the first station, transmitting an address for the resource page to the second client station and, at the second client station, receiving the address of the resource page. Preferably, the address of the resource page is transmitted by way of the server station. Then, at the client station, the browser program may be used to download the resource page onto the client station (e.g., directly from the Internet and not through the server).

In another aspect of the invention, a method is provided for linked browsing over a network such as the World Wide Web. The method includes the steps of providing access to a client-server system having a first client station, a server station, and one or more second client stations, wherein the stations are disposed in electronic communication, and providing a browser program in each of the client stations and a web server program on the server station. The method further includes the steps of operating the browser program on the first client station to retrieve a Universal Resource Locator (URL), transmitting the URL from the first client station to the server station, and operating the web server to send a Hyper Text Mark-up Language (HTML) login page to the first client station.

It should be noted that one particular feature of the invention is its adaptability to the Internet. For this reason, the description provide herein relates primarily to an Internet environment. In another aspect of the invention, a method is provided for connecting browser programs residing on a plurality of client stations and, further, such a system or method which permits linked browsing of Internet content. Such linked browsing allows two or more web users to display, enact, and/or view the same Internet content at the same time. A group of web users known to one another may be linked together by a server system. This linkage permits one web user to act as a guide for other users by allowing the guide to control the web site next visited by all the browser programs used by all members of a designated group of web users. In a further embodiment of the invention, a guide may be able to mark over arbitrary web content appearing on that user's client station such that a corresponding mark appears on the client stations of other users in the group (e.g., at the same time).

The Internet is a collection of computers, computer networks, mobile computers, and other web-enabled devices capable of communicating with one another through different electronic services. As a composite entity, the Internet is sometimes referred to as ‘The web’. The most common services available on the Internet are electronic mail (email) and the World Wide Web (WWW). It is now common knowledge that the Internet has created new ways of carrying out our daily lives, both personal and professional. For example, email has reawakened an almost dormant form of communication—letter writing. Moreover, businesses are still in the first stages of a mad rush to make their products and services available on the Internet. The typical way that information from businesses or individuals is made available on the Internet is through the WWW service.

The WWW service on the Internet permits users to send and receive the contents of web pages. Web pages are the basic method through which information is made available to the heterogeneous computer systems connected to the Internet. Web pages are electronic documents that are displayed and distributed by a computer program called a web server. The web server is the program responsible for sending web pages to other computer systems in response to specific electronic requests issued by these computer systems and placed on the Internet. Web pages can contain a variety of content including graphical images, audio files, video files, streaming audio, streaming video, text, and other forms of information including small computer programs called applets.

One basic concept of organizing information on the Internet is the ‘resource’. As used herein, a resource is any computer system, web page, or equivalent systems, pages, or location containing or embodying content which may be located or accessed. It is likely that this concept will broaden in the future as the number of different web-enabled devices increases. Currently, each resource on the web has a unique identifier (or address) called a Universal Resource Locator (URL). There is a standard protocol for requesting the resource available at a particular URL. In general, a computer system (called the client system) makes a request for the resource (e.g. web page) located at a particular URL. This request can be made in numerous ways; however, the most common is through the use of a browser program on the client computer system. A browser program is a computer program (application program) that acquires, displays, and/or enacts content obtained from the Internet. A browser program may run on any of a variety of hardware platforms including a deskside computer, mainframe computer, handheld computer, web-enabled cell phone, and other mobile and non-mobile web-enabled devices.

To obtain information from the Internet, a browser program puts a URL request onto the Internet, that is, onto the communication networks collectively comprising the Internet. Computer systems connected to the Internet are constantly sampling the URL requests (among other items) and deciding whether to forward the URL request along or whether the request was intended for them. When the web server program on the computer system providing a requested resource (e.g. web page) receives the request, the web server program sends the web page contents back to the requesting client system. In this sense, the web server program ‘serves’ the web page to the client computer. Once the web page is received by the client system making the URL request, the web page is displayed and/or enacted by a browser program on the client.

In the preceding discussion, the browser programs play two central roles: (1) making URL requests, i.e. asking for web pages and their contents, and (2) displaying and enacting web page content once the requested information is received from the web server supporting the requested web page. Web pages are one of two primary means by which personal and professional interactions take place on the Internet (the other is email); therefore, browser programs play a central role in mediating the delivery and display of content present on the Internet.

The use of a browser program to request or display content from the Internet is typically called browsing. Currently, browsing is a solitary activity directed by a human user (the user). The user directs the browser program to request a specific URL either directly or indirectly. The direct way of requesting a specific URL is to type the request into the appropriate entry blank of the browser program typically using a HyperText Transfer Protocol (HTTP) request. One indirect way of requesting a specific URL is by using a mouse or other pointing device to select a hyperlink embedded within a displayed or enacted web page. A hyperlink is a shortcut HTTP request. In any case, the browsing activity, whether directly or indirectly guided, is solitary.

### DETAIL DESCRIPTION OF THE DRAWINGS

FIGS. 1A-1B is an illustration of a general client-server setup for linked browsing;

FIGS. 2A-2B is an illustration of communication and control mediated by the server-client interaction along with a depiction of Internet content downloading in parallel to clients;

FIG. 3 is a screen shot of browsing controls illustrating the general controls and the window for linked group setup;

FIG. 4 is a screen shot of browsing controls illustrating a chat group communication channel among linked group members;

FIG. 5 is an illustration of a daisy-chain map showing a browse map for linked group members;

FIG. 6 is an illustration of a browse map containing a ‘gated’ section controlled by the linked group guide;

FIGS. 7A-7B depict steps for an initial setup of a linked browsing group;

FIG. 8 is a venn diagram illustrating the interrelationship of a communication applet, link browse controls, and a browser program;

FIG. 9 illustrates a feature of the present invention where a link group member annotates a displayed web page;

FIG. 10 is an illustration depicting the annotation of web page content by a link group member.

### DETAILED DESCRIPTION

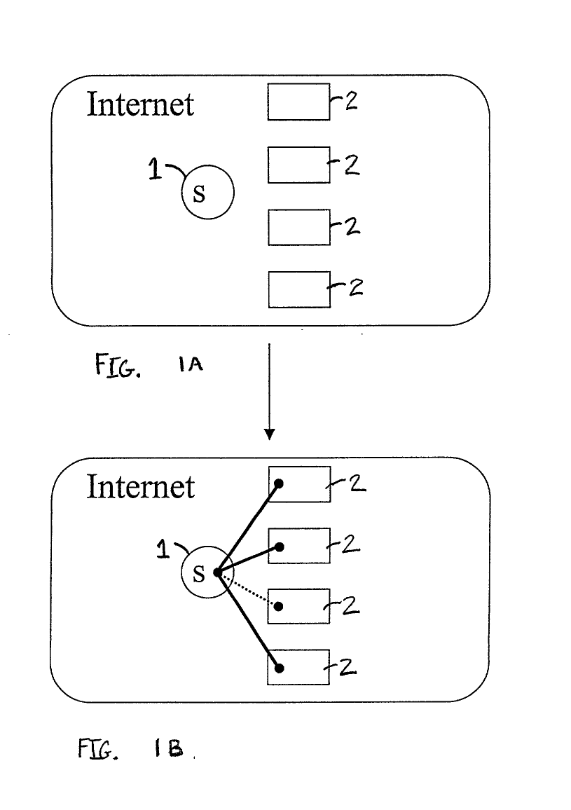

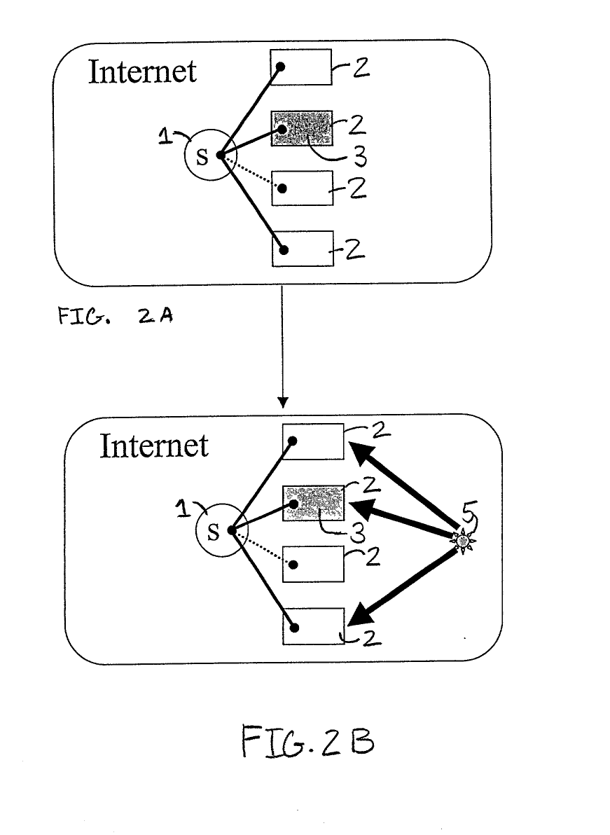

FIGS. 1-10 illustrate multiple aspects of a system and a method for linked communication between client stations linked which embody the invention. FIGS. 1A-1B and 2A-2B illustrate one aspect of the basic system and method of linked browsing. The basic system and method is particularly adapted to include or to be used with the Internet and/or a standard telecommunication network.

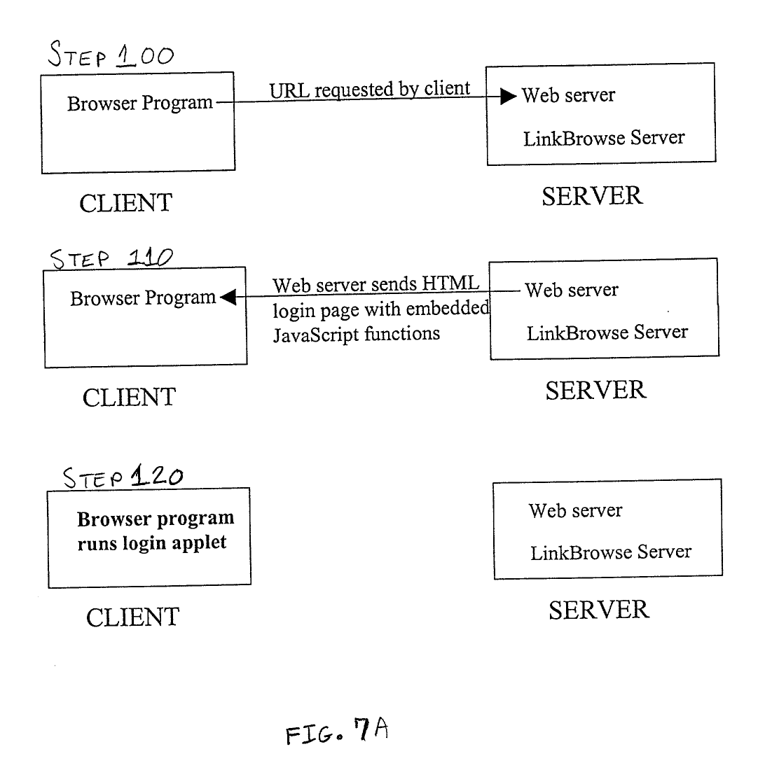

Referring to FIGS. 1A-1B and 2A-2B, one particular aspect of the invention illustrated thereon is a method of linking one or more client stations in a group by sending website addresses through the server and onto each client station, as described below. FIG. 6 further illustrates another aspect of the present inventive system and method relating to browse mapping as one form of guiding or navigating other users through a predefined set of web sites. FIG. 6 also illustrates a specific feature of setting up and utilizing a “gated area” within the browse map. Such gated areas are predefined sets of one or more websites accessible through the browse map in which group members may be allowed (by the guide) to enter and freely explore, but may not exit without permission from the guide.

One specific embodiment of the present invention is a method and system for linked browsing of Internet content present or distributed through web pages. For purposes of this discussion, a “web user” refers to a human who explores and examines content from the Internet typically using, but not limited to, a “browser” program (e.g., Internet Explorer or Netscape Navigator). The concept of linked browsing depends upon a related notion that could be called a linked group. For purposes of the present description, a “browser” is broadly defined to mean a program or programming means which allows a user to navigate (e.g., including view and enact) an interactive computer network/client-server system such as the Internet or an Intranet.

Referring to FIGS. 1A and 1B, a linked group refers a group of web users utilizing client stations 2 linked together by a server system 1. Chat programs are examples of linked groups. Group members control membership in the group and all members of the group view the chat taking place among members. The server system 1 is responsible for receiving and sending chat to clients in the linked group, for maintaining a database of group membership, and for updating the list of group members currently logged. All chat participants view the same text-based dialog at the same time.

In FIG. 1A, the illustration depicts a server system 1 and four client stations 2 before the client stations 2 have connected with the server system 1. A web user utilizing a client station 2 logs into the server system 1. In FIG. 1B, the illustration depicts a group of clients stations 2 set up as a linked group. The server system 1 mediates communication and browser control between the client stations 2. The dark solid lines connecting the client stations 2 to the server station 1 indicate that three of the client stations 2 have been set up as a linked group. The dotted line connecting the client station 2 to the server station 1 represents that the client station 2, although actively logged into the server station 1, is not a member of the linked group.

Now referring to FIGS. 2A-2B, a linked browsing method, according to the invention combines the concept of a linked group and the concept of browsing from the solitary browsing currently permitted by browser programs. Linked browsing may refer to a system that (1) defines a user group and (2) links together their browsing activities so that all members of the group display and enact the same content from the Internet at the same time. In one further embodiment of the invention described herein, a type of linked browsing is described which applies to linked browsing with browser programs. However, as described below, it will be apparent to one skilled in the art, upon reading the Description and/or viewing the Figures provided herein, to implement a type of linked browsing, as discussed herein, using a variety of devices and computational methods.

Linked browsing may be described in the same server-client terminology used above. A server system or server station provides a means by which a linked group of web users communicate with one another and direct the browsing activity of the group. To execute linked browsing, a user on a computer system (a client station) logs in to the server system 1 through a web page initially sent to the client 2 by the server. This web page (the ‘login’ page) is sent to the client 2 when the client's URL request is received by the server. In one embodiment, the web user logs in through the web page and security information is exchanged between client and server to protect both the client 2 and the server 1.

Once proper identification is made, the server 1 sends the client 2 another web page containing HyperText Mark-up Language (HTML) data. This page may also contain a communication applet and/or JavaScript functions. The communication applet establishes a communication channel with both the server program and the browser of the client. The server 1 and client 2 may maintain a database of past linked groups used by the client. The list of group members can therefore be loaded by the client or by the server. After the list of group members is loaded, the server system informs the client which, if any, members of the group are currently logged in. Those groups members currently logged in to the server 1 are shown to the client in a text window, through a voice synthesizer, or any other communication modes understandable by the client. Through an exchange of information through the server 1, the clients decide which members will be linked together for the purpose of browsing Internet content. This group is hereafter called the linked group.

Once communication between clients 2 and server 1 is established and the linked group is defined, the system is ready to mediate linked browsing. Linked browsing is the instance where a member of the group issues a command (containing the URL of a desired web site) to the server system 1 through the communication channel established by the downloaded applet. The server system 1 then broadcasts the URL to all clients 2 of the linked group. The communication applet for each client takes in the URL and sends a command to its browser program to obtain the web page at the specified URL. Preferably, the web page content is downloaded directly from the Internet by each separate browser program. Thus, in this embodiment of the invention, no particular web page content is moved through the server program mediating the linked browsing. In this fashion, one client station 3 in the linked group ‘sends’ all the other clients to the same web page at the same time.

Referring to FIG. 2A, the illustration depicts the same illustration as FIG. 1B, except that one of the client stations have been highlighted in grey and acts as the guide 3. The guide 3 of the linked group sends the web site address to the server 1. The server in turn broadcasts the web site address to the client stations 2 participating in the linked group. In FIG. 2B, the illustration depicts that each client 2 linked in the group receives the new web site address from the server 1. The client 2 thereafter sends the web new web site address to its own browser program. The browser programs then contemporaneously downloads and enacts content from the Internet. The arrows 5 referencing the clients 2 indicate the client stations which receive the new web site address from the server 1.

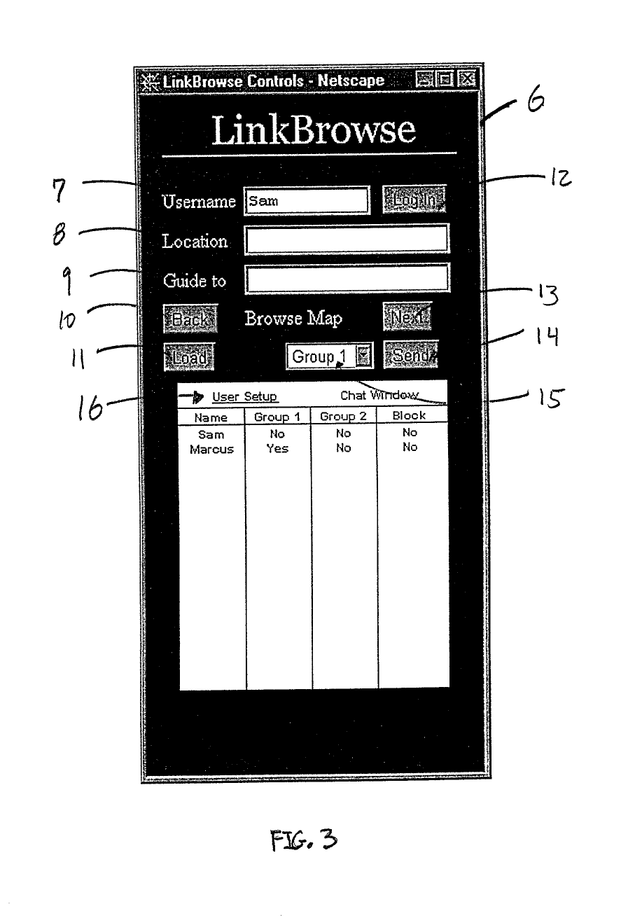

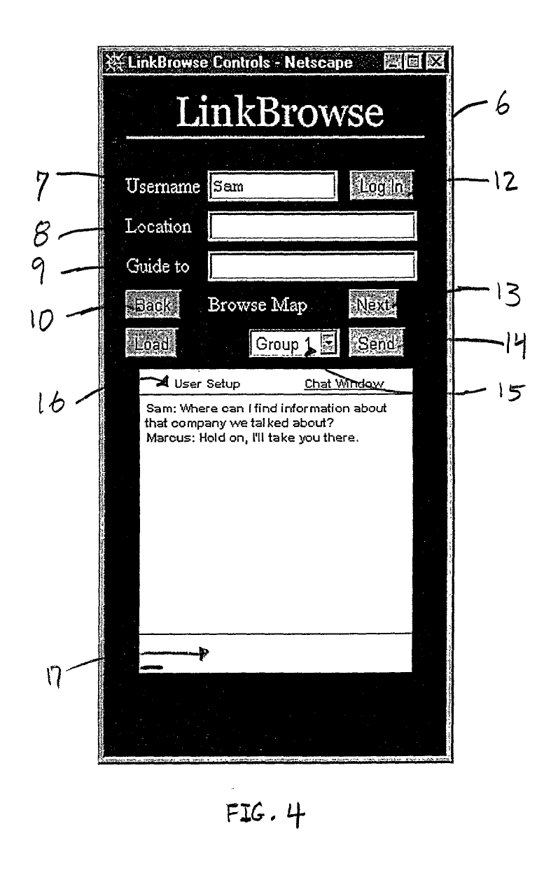

FIGS. 3 and 4 illustrate preferred link browsing controls provided with one embodiment of a system according to the invention. More particularly, FIG. 3 depicts a browser window (also referred to as a communication applet) 6 that may be spawned by a login applet. The login applet may be generated upon completion of such preliminary procedures as security checks and password verification. The browser window 6 appears on the client station 2 and allows for communication with the server 1.

In one embodiment, the link browsing controls provide a user a communication applet 6 containing controls to aid in the creation, management and operation of a linked group. The controls include: a text box labeled ‘Username’ 7 for entry of the name of the use; a ‘Log In’ button 12 for a user to log into the server 1; a text box labeled ‘Location’ 8 for entry of the location; a text box labeled ‘Guide to’ for entry of a URL; a ‘Back’ button 10 and a ‘Next button’ 13 used to navigate the group from web page to web page; a ‘Load’ button 11; a ‘Send’ button 14; a drop-down text box 15 to select the group; and an information screen 16 used to present information about the group information and provide access to a ‘User Setup’ facility.

The communication applet sends and receives information from the server 1. This information includes: (1) browser control commands, that is web site addresses issued from a guide, and (2) communication data for the linked group, that is, chat data or other communications like audio or video. The server system 1 is responsible for managing the linked group and validating security.

FIG. 4 provides an alternate view or shot of the browser window 6. In this view, a client window 6 is being used (and observed) by one or more members of the linked group. In this alternate view, the information screen 16 shows a chat window which provides textual communication information between linked group members. In the illustrated example, the view is of user ‘Sam’ when the ‘Chat Window’ is selected. Data entry for the chat window occurs in the text box 17 at the bottom of the window 6. The area is set off by a horizontal bar, and the cursor position is indicated by a short horizontal bar.

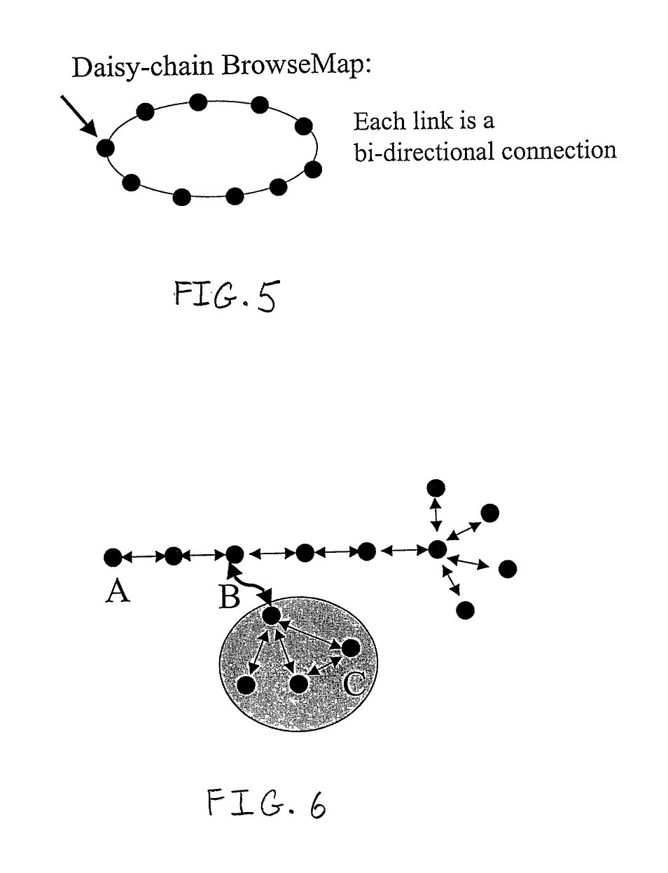

A single client 2 of the linked group may act as a guide 3 for the other members of the linked group. One method for guiding the group through a sequence of web content is to use a browse map. In one aspect of the invention, such a browse map may refer to a pre-defined set of web pages which may be placed in a specific arrangement or scheme. See illustrations provided in FIGS. 5 and 6. Sequencing through a browse map or “link map” is controlled by the guide and is executed by first establishing a linked group, loading the browse map either from the client side or the server side, and pressing ‘back’ and ‘next’ buttons to carry the group from web page to web page. Once a browse map is loaded, a guide can hit the ‘Next’ button 13 or the ‘Back’ 10 button of the communication applet 6 to progress forward or backward through a browse map. The use of a browse map allows a user to collect a complicated sequence of web pages into a simple arrangement for easy, streamlined viewing either by a single user or a linked group of users. Such browse maps can be tailored to the specific needs of an individual or linked group.

In FIG. 5, the illustration depicts the starting point of the browse map with an arrow. Each circle is a pre-defined web site and each curve between web sites is a bi-directional connection, that is, clicking the ‘Next’ button 13, takes the group clockwise and clicking on the ‘Back’ button 10 takes the linked group counter-clockwise in the illustrated browse map.

In FIG. 6, another embodiment illustration a connection scheme utilizing a browse map is illustrated. Each circle illustrates a pre-defined web site and arrows illustrate the permitted transitions in the browse map. Each of the linked group members start at point A in the browse map. Point B identifies a special connection between web sites. The guide 3 controls entry and exit of linked group members. The shaded area identified by point C shows a gated area in the browse map. Linked group members are only allowed in by the guide 3 and thereafter explore freely the gated web sites. The link group members can exit the gated area only under control of the guide 3.

In one relatively open configuration, any member of a linked group may assume the role of guide. In some situations, the role can be limited to a single member of a group in order to facilitate the tour through web content. This latter arrangement would be useful if the guide were an expert like a tour guide, shopping assistant, or other content expert who could choose the appropriate content for the group.

A guide 3 may specify the web site URL address either explicitly by typing or ‘cutting and pasting’ the address into the ‘Guide to’ text box 9 or implicitly by clicking on a hyperlink embedded in a web page. An Internet browser, may be required to first have the default security permissions of the browser extended so that link browsing controls can read the hyperlinks from the web page. An programming industry exists that allows programs and browser applets to read the URL address of hyperlinks in HTML documents. This may require the use of digital certificates.

Upon selection of the web site URL address the guide selects the ‘Send’ button 14 without browse map or the ‘Next’ button 13 or the ‘Back’ 10 button when using the browse map functionality. The communication applet sends the selected URL to the link browse server. The link browse server broadcasts the new URL to all members of a linked group. All of the client side communication applets send the new URL address to their parent browser program. Each of the client's browser programs downloads and enacts web content from the new URL. The result is that all of the client's web browser view the same web site contemporaneously.

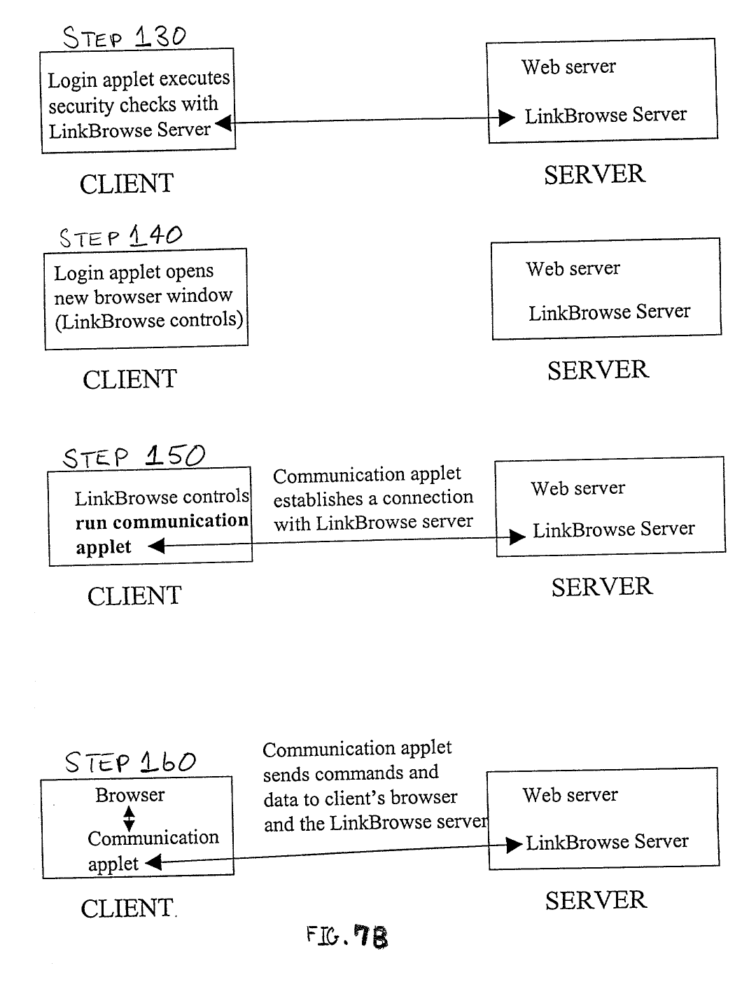

FIGS. 7A-7B briefly summarizes a typical setup for linked browsing in accordance with the present invention. In a first step 100, a client station utilizing a browser program sends a URL request to a server. This step is followed by the steps 110 of the webserver serving an HTML login page (e.g., with embedded JavaScript functions) to the browser program of the client situation and the client's browser program runs the login applet (step 120). The login applet then executes security checks (step 130) with the linked browse server by utilizing link browse controls such as those previously described with respect to FIGS. 3 and 4.

In step 140, the login applet is used to open the new browser window (link browse controls). The link browse controls then runs the communication applet (step 150), so as to establish communication or connection with the link browse server. Thereafter, the communication applet sends command and data to the client's browser and the link browse servers, (as illustrated in step 160). At this point, the set-up is considered complete, and the system is ready for use. That is, the link group membership has been defined, the communication is mediated, and control of link browsing by the link group is implemented.

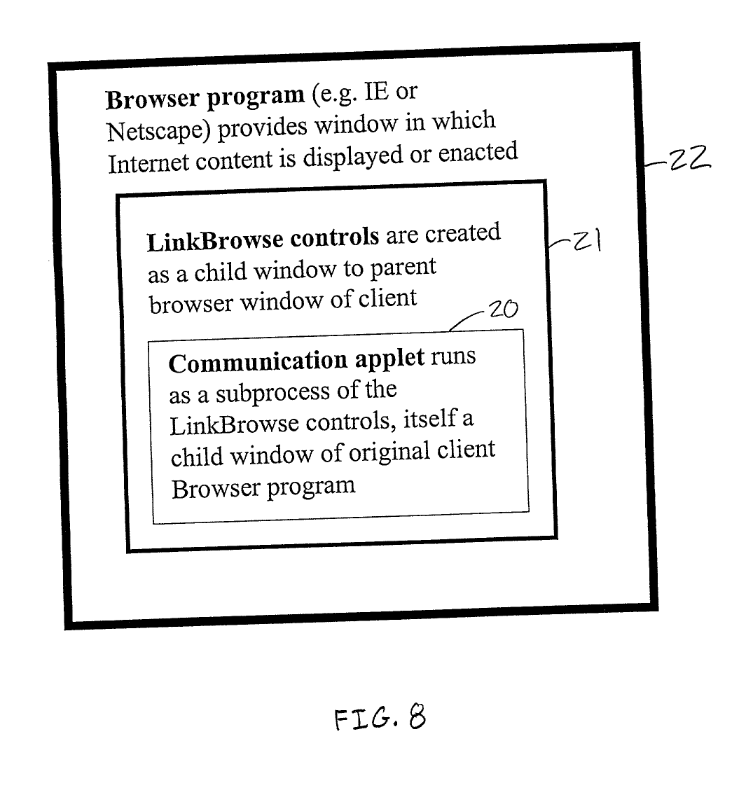

FIG. 8 illustrates certain relationships in the link browse, as it appears on a client station 2. Typically, a browser program 22 resides and is operable on the client station 2, but is supplemented by link browse controls 21 and a communication applet 20 upon operation of the present inventive system.

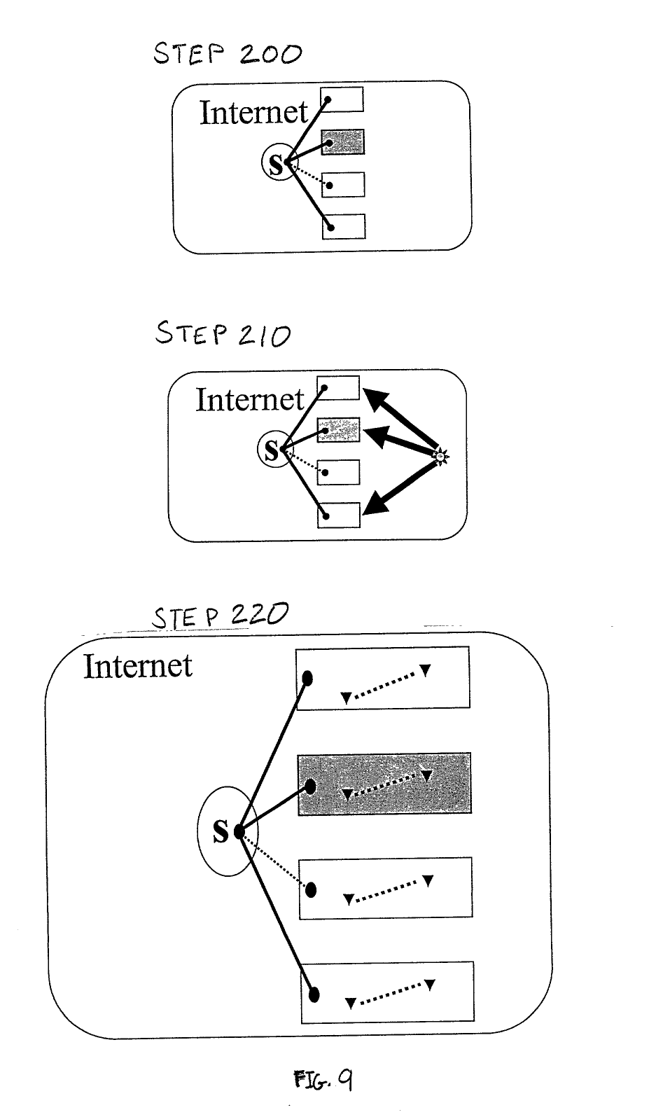

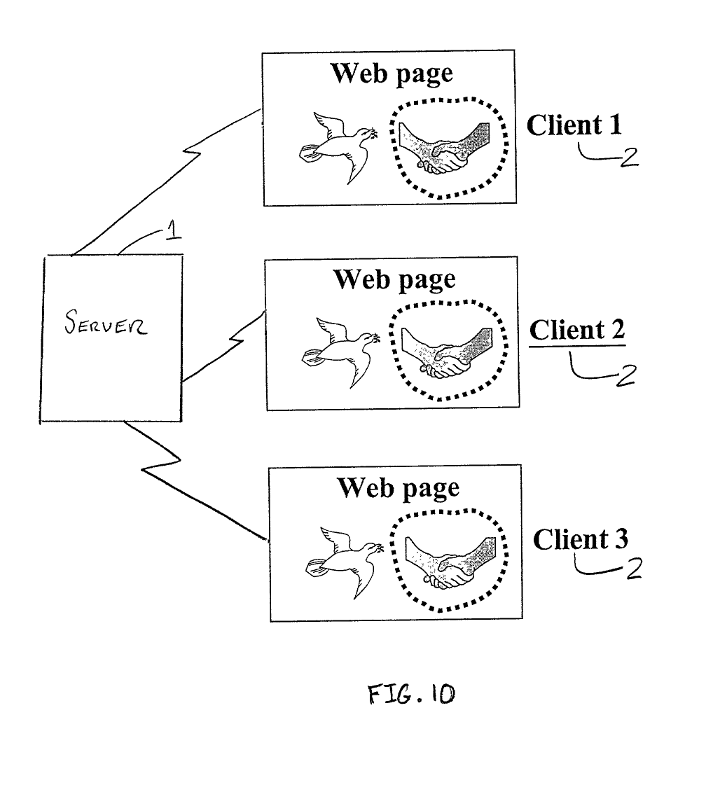

FIGS. 9-10 illustrate further aspects of the present inventive system and method. In particular, FIG. 9 illustrates the use of a “browser buddy” or “link buddy” feature. In step 200, a linked group is established via the link browse server. In step 210, the content of the selected web site is downloaded under the control of the guide. In step 230, the guide or other link group members annotate the web page which contemporaneously displays the annotations over the other members web pages. The browser buddy system or feature allows a guide or other user to mark on its client station's web content which may appear on the other client stations. Then, as a user moves a pointer over its current web page, the pointers in all of the group members' client stations move in tandem over the web pages. (See step 230.) It should be noted that, as illustrated in these Figures, a member of the group may be selectively enabled/disabled.

FIG. 10 illustrates yet another inventive feature or aspect, relating to the highlighting or continuous marking of web content. After the web pages are loaded, one user makes a continuous drawing or mark over a current web content or its client station. The mark over the first client station's content appears as a corresponding mark over the web content on each of the other client stations. That is, the mark may be viewed by all the users of the link group. As will be apparent to any user, these features facilitate communication and understanding between the members of the web group.

The foregoing description of the present invention has been presented for purposes of illustration and description. The description is not intended to limit the invention to the form disclosed herein. Consequently, variations and modifications to the inventive system and method commensurate with the above teachings and the skill and teaching of the relevant art (e.g., the relevant Internet, software applications or electronic commerce art) are within the scope of the invention. For example, as mentioned previously, several aspects of the invention may be adapted for application or implementation onto an interactive computer network or client-server system other than the Internet. Further, the client computer systems for linked browsing may be any deskside computer, computer network, or any other mobile or non-mobile web-enabled devices such as cell phones, personal digital assistants (e.g., Palm Pilots), web-enabled refrigerators or other appliances.

Moreover, different aspects of the invention may be adapted to existing linked browsing methods or their equivalents, which may be in theory or application are different to the linked browsing or communication system and method described herein. For example, such aspects or features of the invention referred to herein as browse buddy, map browsing, synchronization of browsers, or common sizing, may be used in alternative linked or linked communication models. Further, in one aspect of the invention, communication among members of the linked group takes place through a standard text-based chat interface. It should be noted, however, that this communication may also take place through normal telephony, Internet telephony, standard video conferencing (audio and/or video link), Internet video conferencing (audio and/or video link).

What is claimed is:

1. A method implemented via a client-server system for allowing a first client station to cause a second client station to display a predetermined resource page, said method comprising the steps of:
providing access to a client-server system including a first client station, a second client station, and a server station, the stations being disposed in electronic communication;
providing a browser program for displaying resource pages on the second client station;
at the first station, transmitting an address for the resource page to the second client station;
at the second client station, receiving the address of the resource page from the server station; and
at the client station, operating the browser program to download the resource page.

2. The method of claim 1, wherein the step of providing access to a client-server system includes providing access to the Internet.

3. The method of claim 2, wherein the resource page is a web page, and wherein the transmitting step includes transmitting the URL of the predetermined web page.

4. The method of claim 1, wherein the step of providing access to a client-server station includes providing a server station configured to mediate communication between the first client station and one or more passenger stations, including the second client station.

5. The method of claim 1, wherein the transmitting step includes sending the resource address from the first client station to the server station and, then, operating the server station to broadcast the resource address to the second client station.

6. The method of claim 5, wherein the step of receiving the resource address from the server, includes sending the address to the browser program on the second client station, and operating the browser program to download content.

7. The method of claim 6, further comprising the step of generating a browser window on the second client station, whereby the browser window communicates with the server station through a communication applet.

8. The method of claim 7, further comprising the steps of:
providing a communication applet on the second client station; and
operating the communication applet on the second client station to transmit information from the server station.

9. The method of claim 8, further comprising the step of operating the communication applet to communicate data between the first and second client station.

10. The method of claim 8, further comprising the step of operating the communication applet to receive data input from a user.

11. An interactive computer system for allowing a first computer to cause one or more second computers to display a predetermined web page, said system comprising:
at least one first computer connected to computer network;
one or more second computers connected to the computer network; and
a server computer connected to the computer network, the server computer having a computer program storage device and a program residing thereon, the program including instructions executable by the server computer for performing a method of transmitting a pre-selected URL resource address from the first computer to the second computer, the resource address identifying a predetermined web page to one or more of the second computers for access thereon and such that the predetermined web page may be displayed by each of the second computers.

12. The system of claim 11, wherein the second computer includes a browser program for downloading files received from the server computer.

13. The system of claim 12, further comprising programming means for linking the one or more second computers with one or more second computers, such that a first computer controls, at least partially, the browser program on the one or more second computers.

14. The system of claim 13, further comprising programming means for predefining a set of websites and a connection scheme among the websites, the programming means being operable by a user of a first computer to control, at least partially, browser navigation on the one or more second computers.

15. The system of claim 11, further comprising programming means for defining a set of website URLs, such that the second computers may be guided through one or more of the websites defined by the set of URLs.

16. A method of annotating a web page via an interactive computer network, said method comprising the steps of:
providing access to an interactive computer network including a first computer, a server, and one or more second computers;
providing a first annotation program operable with a first web browser residing on the first computer;
providing a second annotation program operable with a second web browser residing on one of the second computers;
operating the first annotation program to annotate the web content residing on the first computer;
at the server, receiving input from the first annotation program representative of the annotation provided on the web content;
operating the server to interact with the second annotation program so as to annotate the web content residing on the second computer such that the annotation provided thereon corresponds to the annotation provided on the first computer.

17. The method of claim 16, further comprising the step of operating the first computer to move a mark placed on the web content thereon, to a different location on the web content thereon, such that the corresponding mark appearing on the second computer moves to a second location on each of the web content displayed thereon, wherein the second location on the second computer corresponds to the second location on the web content of the first computer.

18. The method of claim 17, further comprising the step of operating the first computer to mark over a discrete location on the arbitrary web content appearing thereon, such that a corresponding mark is made over a corresponding location on the web content appearing on the second client station.

19. The method of any one of claim 16, further comprising the step of synchronizing pointers on each of the second computers to correspond to a location of a pointer on the first computer.

20. The method of claim 16, further comprising the steps of sizing a window for displaying web content on each of the second computers such that the window corresponds to the size of a corresponding window for the web content appearing on the first computer.

21. The method of claim 16, further comprising the steps of operating the first client station as a pilot station and restricting navigation of the world wide web on each of the second client stations.

22. A method for linking at least one pilot client station with a plurality of passenger client stations and guiding each of the passenger stations through a plurality of web sites, the method comprising the steps of:
providing access to a network in communication with the Internet and including a pilot client station, one or more passenger client stations, and at least one server station disposed in communication with each of the pilot and passenger stations;
providing a server program on the server station operable to facilitate communication between the pilot station and the passenger stations;
providing a browser program on each of the pilot and passenger stations, the browser programs on the passenger stations being operable to download web content upon receipt of a URL;
operating the pilot station to define a set of website URLs;
transmitting the set of predefined URLs to each of the passenger stations; and
guiding each of the passenger stations through one or more of the websites defined by the set of URLs, the guiding step including operating the browser program on each of the passenger stations to download the content of a web page using the URL transmitted thereto.

23. The method of claim 22, wherein the transmitting step includes transmitting the URLs via the server station.

24. The method of claim 22, wherein the guiding step includes guiding each of the passenger stations to a website, including preventing the passenger stations from accessing a website other than one common website designated by operation of the pilot station.

25. The method of claim 24, wherein the guiding step further includes the step of defining a subset gated community comprising a predefined collection of URLs, and wherein the guiding step further includes the step of guiding each of the passenger stations into the gated community, whereby each of the passenger stations can freely move between one or more of the collection of predefined URLs.

26. The method of claim 22, wherein the guiding step includes operating the browser program on each of the passenger stations to download web content directly without passing content through the server station.
